(19) United States
(12) Patent Application Publication
(10) Pub. No.: US 2019/0009917 A1
(43) Pub. Date: Jan. 10, 2019

(54) DRIVE SYSTEM AND METHOD FOR DRIVING A PROPULSION DEVICE OF A VEHICLE USING CRYOGENIC COOLING

(71) Applicants: Frank Anton, Erlangen (DE); Tabea Arndt, Erlangen (DE); Mykhaylo Filipenko, Erlangen (DE); Agnieszka Makowska, Fürth (DE)

(72) Inventors: Frank Anton, Erlangen (DE); Tabea Arndt, Erlangen (DE); Mykhaylo Filipenko, Erlangen (DE); Agnieszka Makowska, Fürth (DE)

(21) Appl. No.: 15/748,778

(22) PCT Filed: Jun. 15, 2016
(86) PCT No.: PCT/EP2016/063731

§ 371 Date: Jan. 30, 2018

(30) Foreign Application Priority Data
Aug. 7, 2015 (DE) 102015215130.1

(51) Int. Cl. B64D 27/24; H02K 55/04

(52) U.S. Cl. CPC B64D 27/24; B60L 11/12; H02K 55/04

(57) ABSTRACT

The disclosure relates to a drive system and to a method for providing kinetic energy for a propulsion device of an aircraft. The drive system is designed as a series hybrid system, which has an electric motor for driving the propulsion device, a generator for providing the electrical energy for the electric motor, and an internal combustion engine for providing the kinetic energy for operating the generator. The generator is designed as a superconducting generator. Hydrogen is used as a coolant for the generator. As soon as the hydrogen in the region surrounding the generator exceeds a specified temperature, the hydrogen is drawn from the generator in the gaseous state and fed to a device, which processes the hydrogen in such a way that energy that may be used in the drive system is provided. The device may be a fuel cell and/or the internal combustion engine designed as a hydrogen turbine, for example.

The present patent document is a § 371 nationalization of PCT Application Serial Number PCT/EP2016/063731, filed Jun. 15, 2016, designating the United States, which is hereby incorporated by reference, and this patent document also claims the benefit of DE 10 2015 215 130.1, filed Aug. 7, 2015, which is also hereby incorporated by reference.

### TECHNICAL FIELD

The disclosure relates to a drive system for providing kinetic energy for a propulsion device of a vehicle, in particular, an aerial vehicle.

### BACKGROUND

For driving vehicles, hybrid concepts are being investigated and used as an alternative to the customary internal combustion engines. In particular, serial hybrid approaches have a number of advantages.

In the case of a serial hybrid drive system, electrical energy is provided with the aid of a generator, which is coupled to an internal combustion engine and is driven by it. This electrical energy is subsequently fed to an electric motor, which converts the fed electrical energy into drive energy for a propulsion device of the aerial vehicle, (e.g., a propeller). The advantage of this concept is that both the electric motor and the internal combustion engine may run at different rotational speeds. Consequently, in particular, the internal combustion engine may be operated in the optimum speed and load range at all times, so that the maximum power outputs and maximum efficiencies may be achieved. In addition, it is possible to dispense with the complex mechanisms for connecting the internal combustion engine to the propulsion device.

For aviation, the power-to-weight ratio of the drive system, e.g., the quotient of the power achievable with the drive system and its mass, is crucial. The drive system provides a thrust power, and consequently generates a lift, that is sufficient to overcome the force of gravity. To be able to produce generators with the highest possible power-to-weight ratio, the concept of superconduction may be used, for example, in the design of the generators. On the one hand, superconductors allow very high magnetic flux densities to be realized. On the other hand, superconductors may carry very high current densities. As a result, the cross-sectional area of the turns of the current-carrying coils of the generator may be reduced significantly, and as a result, the mass of the machine may be reduced. Such superconducting generators may contain superconducting components, for example, in the stator and/or in the rotor.

Because the transition temperature, below which the effect of superconduction commences, of all superconductors known to date lies in the cryogenic range, (e.g., currently below 170 K), a cooling apparatus is needed for the operation of a superconducting generator. For cooling the superconducting components of a superconducting generator, a coolant may be first liquefied by a cryocooler and transported in the liquid state and at a very low temperature to the superconducting component or components of the generator and brought into thermal contact with it or them.

A known coolant is, for example, neon, which may be used at a temperature of about 27 K. One disadvantage of this is that the cryocooler including a cooling head and a compressor has a great weight. Another disadvantage is that the neon coolant is a rare and expensive medium, for which reason the coolant may be recirculated and collected in an appropriate tank. This likewise increases the weight of the overall system, which has adverse effects on the power-to-weight ratio.

Instead of neon, liquid nitrogen may also be used for the cooling. However, nitrogen has the disadvantage that, at 77 K, its transition temperature is comparatively high. At this temperature, the critical currents and magnetic fields are much smaller than at 27 K, for which reason the advantages of superconduction cannot be fully exploited, which likewise has adverse effects on the power-to-weight ratio.

### SUMMARY AND DESCRIPTION

The object of the disclosure is therefore to provide an approach for an improved concept in terms of the power-to-weight ratio for a serial hybrid drive system for a vehicle.

The scope of the present disclosure is defined solely by the appended claims and is not affected to any degree by the statements within this summary. The present embodiments may obviate one or more of the drawbacks or limitations in the related art.

Specifically, a drive system for driving a propulsion device of a vehicle, (e.g., an aerial vehicle), has an electric motor for driving the propulsion device and a generator for providing a first electrical energy EE. In this case, the generator is electrically connected to the electric motor, in order to feed at least a first part EE1 of the first electrical energy EE to the electric motor for driving the electric motor.

The generator is a cryogenic generator, (e.g., a superconducting generator), which has at least one cryogenic component, which may be brought to a cryogenic temperature by a coolant that may be fed to the generator, and consequently to the component, may be hydrogen and is in particular in a liquid state. The cryogenic component has at the cryogenic temperature a conductivity that is increased or improved by at least one order of magnitude as compared with its conductivity at room temperature or, for example, at 0° C. The generator is also connected to at least one device of the drive system to which at least a part of the coolant may be passed in a gaseous state, after satisfying a predetermined criterion and which is designed to process the fed coolant in such a way that an energy EEB, KEG that may be used in the drive system is provided.

As already indicated, the generator may be a superconducting generator, which has at least one superconducting component which, when the component is at a corresponding temperature, is in a superconducting state. For this purpose, the coolant, (e.g., hydrogen in a liquid state), is fed to the generator and to the superconducting component.

Here and hereinafter, the term cryogenic generator means that at least one component of the generator, (e.g., a magnetic coil), is cryogenically cooled and is accordingly at a cryogenic temperature, (e.g., at an extremely low temperature), at which the conductivity is improved for example by a factor of 3 or more as compared with room temperature. In an analogous way, for example, the term cryogenic component may also be understood as meaning that this component is cryogenically cooled.

For example, it is conceivable to produce the cryogenic component from copper or aluminum and to cool the component to a temperature of 21 K. Although at this temperature these metals are still not superconducting, the metal's resistance falls by three orders of magnitude as compared with the resistance at room temperature, which already represents a great advantage.

In one configuration, the cryogenic cooling proceeds to the extent that the cooled component goes over into a superconducting state. For this purpose, this component includes a material that goes over into the superconducting state when the temperature goes below the transition temperature of this material. Accordingly, the term superconducting generator means that at least one component of the generator, (e.g., the magnetic coil), is superconducting or includes a material that goes over into the superconducting state when the temperature goes below the transition temperature of this material. In an analogous way, for example, the term superconducting component may also be understood as meaning that this component includes a material that goes over into the superconducting state when the temperature goes below the transition temperature of this material.

Because the coolant may be hydrogen, the fuel cell is consequently a hydrogen-oxygen fuel cell. The reaction product is accordingly deionized water, which has the advantage that the parts of the electric motor that are cooled by the reaction product and also the media connection are attacked only little by the water. The same applies to the method described below.

The device referred to may be a fuel cell, the generator being connected to the fuel cell by way of a first media connection. By way of the media connection, at least a first part of the coolant may be passed in a gaseous state from the generator to the fuel cell after satisfying the predetermined criterion. The coolant enters into a chemical reaction in the fuel cell with a reaction partner, producing a second electrical energy EEB and a reaction product H2O. The fact that the device, in this embodiment the fuel cell, is located downstream of the cooled system means that efficient use of the coolant, beyond the actual use for cooling the generator or the component, is made possible.

The fuel cell is connected to the electric motor by way of a second media connection, by way of which the reaction product H2O may be fed to the electric motor as a cooling medium in order to cool it.

Furthermore, the fuel cell may be electrically connected to one or more electrical components of the aircraft, in order to provide at least a part EEB1, EEB2, EEB3 of the second electrical energy EEB in each case to the electrical components for being used in the respective electrical component. The electrical components may include the electric motor, a battery of the drive system, or else other electrical loads of the vehicle. For example, it is conceivable that the electrical energy stored in the battery is fed as and when required to the electric motor and/or to one or more electrical loads of the vehicle, (e.g., a lighting system).

The fuel cell may therefore be electrically connected to the electric motor, it being possible for at least a first part EEB1 of the second electrical energy EEB to be passed from the fuel cell to the electric motor for driving the electric motor.

As an alternative or in addition, it may be that at least a second part EEB2 of the second electrical energy EEB may be fed to this battery and may be stored there. In this case, the battery may be electrically connected to one or more of the electrical components of the vehicle, so that electrical energy EE stored in the battery may be provided to the respective electrical component.

With each of the various uses referred to of the reagents H2O, EEB of the fuel cell, a further-improved efficiency of the use of the coolant is made possible.

The drive system may also have an internal combustion engine for driving the generator. The internal combustion engine is designed to provide kinetic energy KEG by burning a medium, and is mechanically connected to the generator, in order to feed the provided kinetic energy KEG to the generator. The generator converts the fed kinetic energy KEG into the first electrical energy EE, of which at least a first part EE1 is provided to the electric motor in order to drive it. In this way, the drive system is therefore a serial hybrid system.

Advantageously, the medium to be burned in the internal combustion engine is the coolant. For this purpose, the generator is connected to the internal combustion engine by way of a third media connection, by way of which at least a second part of the coolant may be passed in a gaseous state from the generator to the internal combustion engine after satisfying the predetermined criterion, in order to be burned there.

In this case, the internal combustion engine therefore represents the device to which at least a part of the coolant may be passed after satisfying the predetermined criterion and which is designed to process the fed coolant in such a way that an energy that may be used in the drive system is provided. The fact that here too the device, in this embodiment the internal combustion engine, is located downstream of the cooled system means that efficient use of the coolant, beyond the actual use for cooling the generator or the component, is made possible.

The predetermined criterion referred to may be that of exceeding a predetermined temperature. Exceeding this temperature would have the consequence that the cooling of the generator or of the component takes place less efficiently, the coolant in particular going over into the gaseous state when the temperature is exceeded. The criterion may therefore also be the state of aggregation of the coolant, so that the coolant or at least a part thereof is passed or may be passed to the device as soon as it is in the gaseous state.

In a corresponding method for operating a drive system for driving a propulsion device of a vehicle, the propulsion device is driven by an electric motor of the drive system. A generator of the drive system feeds a first electrical energy EE to the electric motor, in order to drive the electric motor. The generator is a cryogenic generator, (e.g., a superconducting generator), which has at least a cryogenic or possibly superconducting component, which component is brought to a cryogenic temperature by a coolant that may be fed to the generator and to the component and which component has at the cryogenic temperature a conductivity that is increased by at least one order of magnitude as compared with its conductivity at room temperature or for example at 0° C. After satisfying a predetermined criterion, at least a part of the coolant is passed, (e.g., in a gaseous state), from the generator to at least one device of the drive system, which processes the fed coolant in such a way that an energy EEB, KEG that may be used in the drive system is provided.

The coolant is in particular hydrogen, which for cooling the generator or the component may be in a liquid state.

In one embodiment, the device is a fuel cell, at least a first part of the coolant being passed, (e.g., in a gaseous state), from the generator to the fuel cell after satisfying the predetermined criterion. The coolant enters into a chemical reaction in the fuel cell with a reaction partner O2, producing a second electrical energy EEB and a reaction product H2O.

The reaction product H2O is fed to the electric motor as a cooling medium, in order to cool the electric motor.

At least a first part EEB1 of the second electrical energy EEB is passed from the fuel cell to the electric motor for driving the electric motor.

The drive system may have a battery, wherein at least a second part EEB2 of the second electrical energy EEB is fed to and stored within the battery. The battery is electrically connected to one or more electrical components of the vehicle, so that electrical energy EE stored in the battery is provided to the respective electrical component.

The generator is driven by an internal combustion engine of the drive system. The internal combustion engine provides kinetic energy KEG by burning a medium. The provided kinetic energy is fed to the generator and the generator converts the fed kinetic energy KEG into the first electrical energy EE. Of the first electrical energy EE, at least a first part EE1 is provided to the electric motor in order to drive the electric motor.

The medium to be burned may be the coolant, wherein at least a second part of the coolant is passed from the generator to the internal combustion engine in a gaseous state after satisfying the predetermined criterion, in order to be burned there.

The predetermined criterion may be that of exceeding a predetermined temperature or reaching a specified state of aggregation of the coolant, (e.g., reaching the gaseous state of aggregation).

The vehicle may be an aerial vehicle, (e.g., an aircraft). The described drive system may however also be used for hybrid road vehicles or trains.

Apart from the advantages of the serial hybrid concept that were already mentioned at the beginning, the concept presented here yields many further benefits. Hydrogen is advantageously used as the coolant. The boiling temperature of liquid hydrogen is 21 K, so that the components cooled by liquid hydrogen may be transformed into a state in which their conductivity already allows very efficient operation as a result of the superconduction occurring. By contrast with neon, the hydrogen does not have to be recovered or collected, but instead the water produced in the chemical reaction in the fuel cell may be given off directly and/or used for other purposes, e.g., on board the vehicle.

It is particularly advantageous for the power-to-weight ratio that the weight and the power consumption of a cryocooler are eliminated.

In addition, power or electrical energy is generated in the fuel cell and may be used in corresponding electrical components of the vehicle. The electrical components may be the electrical equipment of the vehicle, such as for instance a lighting system or the like. Furthermore, the electrical energy may be fed to a battery of the vehicle and stored there. This stored energy may be used for supplying power to the electric motor for driving the propulsion device and/or the electrical equipment of the vehicle, the former in particular during takeoff or landing of the aircraft. The electrical energy from the fuel cell may also be fed directly to the electric motor.

If the internal combustion engine is designed as a hydrogen turbine, there is additionally the advantage of an ecological reagent, because hydrogen is then burned in place of kerosene, for example.

One of the points of the approach presented here is that the power-generating elements, (e.g., the fuel cell and/or the internal combustion engine), are located downstream of the cooled system, whereby efficient use of the coolant is made possible.

### BRIEF DESCRIPTION OF THE DRAWINGS

The disclosure and exemplary embodiments are explained in more detail below on the basis of a drawing, in which:

FIG. 1 depicts a serial hybrid drive system of an aircraft for driving a propulsion device of the aircraft in a first embodiment.

FIG. 2 depicts the serial hybrid drive system in a second embodiment.

FIG. 3 depicts the serial hybrid drive system in a third embodiment.

The same designations identify the same components in different figures.

### DETAILED DESCRIPTION

In the following, a mechanical connection of two components refers to a connection that allows the transmission of kinetic energy, (e.g., rotational energy), from one of the components to the other. In practice, the transmission of the kinetic energy, (e.g., from a motor to a generator), means that a shaft that is set in rotation by the motor drives a rotor of the generator, so that the kinetic rotational energy made available by the motor is used in such a way that the rotor of the generator is for its part set in rotation, and accordingly kinetic energy was fed to it.

In an analogous way, an electrical connection of two components allows the transmission of electrical energy from one component to the other.

In the case of the mechanical connection, the connected components may be the internal combustion engine referred to, which brings about a rotation of a shaft, and the electrical generator. These components are mechanically connected to one another by way of suitable components. The suitable components may be shafts, spindles, gear mechanisms, etc. The kinetic energy transmitted from the motor to the generator is converted into electrical energy in the generator. This generator may be electrically connected to an electric motor in order to make available to the electric motor the electrical energy required for its operation. An electrical connection may be realized with the aid of a cable.

For the sake of clarity, in the figures, the mechanical and electrical connections are not provided with individual designations apart from a few exceptions. The arrows indicated in the figures symbolize the direction of flow of the form of energy respectively transmitted from one component to the other, (e.g., electrical or kinetic energy). In this case, double-headed arrows symbolize the transmission of mechanical energy, while dashed arrows indicate the transmission of electrical energy. Single, solid arrows symbolize the flow of liquid or gaseous media, (e.g., fuel or coolant).

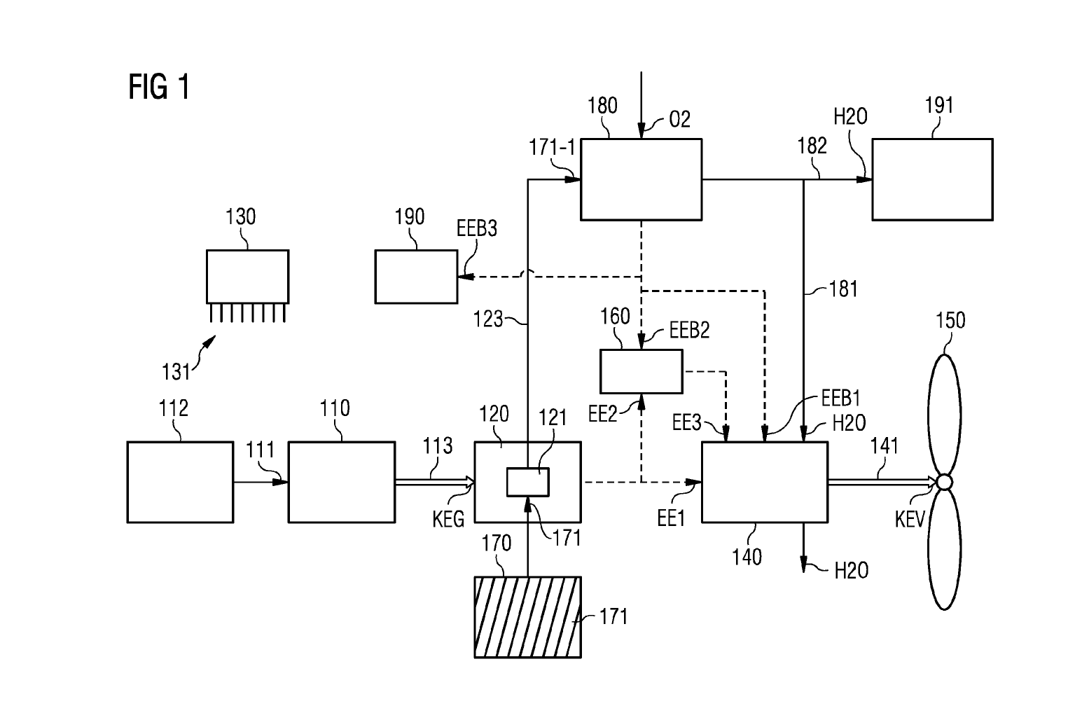

FIG. 1 depicts in a schematic representation a first embodiment of a serial hybrid drive system 100 for a vehicle 1, the vehicle 1 being representative, by way of example, of an aerial vehicle, (e.g., an aircraft).

The drive system 100 has an internal combustion engine 110, which obtains the medium 111 to be burned from a tank 112. The medium 111 depends on the type of internal combustion engine 110. In the event that the vehicle 1 is an aircraft, the medium 111 may be kerosene, for example.

By burning the medium 111, the internal combustion engine 110 makes kinetic energy KEG available, (e.g., rotational energy). The kinetic energy is fed by way of a mechanical connection 113, (e.g., a shaft), to a generator 120, which converts the kinetic energy KEG into electrical energy EE.

As and when required, and influenced by a control unit 130, a part EE1 of the electrical energy EE is fed to an electric motor 140 of the drive system 100, which converts this electrical energy EE1 into kinetic energy KEV. The kinetic energy KEV thus provided is fed by way of a further mechanical connection 141 directly, or possibly by way of the suitable components mentioned (not shown), to the propulsion device 150. The propulsion device 150, (e.g., in the case of an aerial vehicle 1, a propeller), is consequently driven by the kinetic energy KEV and thus provides the propulsion of the aerial vehicle 1. In this case, the term propulsion is not necessarily intended to mean that the vehicle 1 is moved in a forward direction. The term propulsion merely implies that the vehicle 1 is moved, but is not restricted to a forward or rearward direction, etc.

For example, for the case where the electric motor 140 is momentarily not being operated at full power, and therefore only electrical energy that is less than the energy EE provided by the generator 120 is required, that proportion EE2 of the electrical energy EE that is not provided to the electric motor 140 may be fed to a battery 160 and stored there. For this purpose, the battery 160 is electrically connected to the generator 120. The battery 160 is also electrically connected to the electric motor 140, so that, for example, for the case where the electric motor 140 requires more electrical energy than the generator 120 delivers or may deliver, electrical energy EE3 may be made available to the electric motor 140 by the battery 160. The electrical energy stored in the battery 160 may also be used for supplying power to electrical loads 190 of the aircraft, (e.g., a lighting system 190).

In the case of the serial hybrid drive system 100, therefore, the internal combustion engine 110 is not connected for direct power transmission or not connected mechanically to the propulsion device 150. The internal combustion engine 110 is merely used to drive the generator 120, which for its part supplies electrical energy to the electric motor 140, and possibly the battery 160.

In the case of the serial hybrid concept, the propulsion of the vehicle 1 is brought about exclusively by the electric motor 120.

The generator 120 may be a superconducting generator, in the design of which the concept of high-temperature superconduction (HTS) was used in particular. The HTS generator 120 has superconducting components 121, it being possible depending on the type of construction of the HTS generator 120, for example, for the stator and/or the rotor or the magnetic coils of the generator 120 to be designed as superconducting components 121. In a tank 170, a liquid coolant 171 is kept for the cooling of the generator 120 or of the superconducting components 121 that is accordingly necessary. The liquid coolant 171 is liquid hydrogen. As and when required, the hydrogen 171 is directed from the tank 170 to the superconducting components 121 of the HTS generator 120 (e.g., controlled by the control unit 130), in order to cool them to a predetermined target temperature at or below the transition temperature.

The temperature of the hydrogen located outside the tank 170 and in the vicinity of the generator 120 will rise over time and during the operation of the drive system 100 and of the generator 120. As soon as a predetermined temperature is exceeded, hydrogen 171-1 is taken from the HTS generator 120 in a gaseous state and directed by way of a media connection 123 to a fuel cell 180 of the drive system 100. This also takes place under the control of the control unit 130, which monitors the temperature of the superconducting components 121 and of the hydrogen 171 in the vicinity of the HTS generator 120, for example, by way of corresponding sensors that are not shown. When the temperature rises above the predetermined target temperature, the control unit 130 brings about, for example, an actuation of corresponding valves, etc., so that the hydrogen 171-1 reaches the fuel cell 180 in a gaseous form.

In the fuel cell 180, the hydrogen 171-1 is brought into contact with oxygen O2, which may be taken from the environment. Hydrogen 171-1 and the reaction partner oxygen O2 enter into a chemical reaction, producing electrical energy EEB and a reaction product H2O in a known way. The electrical energy EEB may be fed to one or more electrical components of the aerial vehicle 1. Such an electrical component may be the electric motor 140. At least a part EEB1 of the electrical energy EEB may accordingly be fed to the electric motor 140, in order to drive the motor. A further electrical component may be the battery 160. Possibly, a part EEB2 of the second electrical energy EEB is therefore fed to the battery 160 and stored there, so that it is available for further uses. In addition, the electrical components may also include various other electrical loads 190 of the aerial vehicle and a part EEB3 of the electrical energy EEB is fed to these various electrical loads 190 of the aerial vehicle 1, in order to operate them. Such an electrical load may be for example a lighting system 190 of the aerial vehicle 1.

Deionized water H2O is obtained as a further reagent of the fuel cell 180 or as a reaction product. This deionized water H2O is fed by way of a media connection 181 as a cooling medium to the electric motor 140, in order to cool it before it is given off into the environment. The use of the deionized water as a coolant is advantageous over the use of normal water, (e.g., in connection with an electric motor), because when normal water is used, there is the risk of short-circuits occurring.

Once the deionized water H2O has passed through the electric motor 140 for the purpose of cooling and/or the system 191, the water may be discharged into the environment.

As an alternative or in addition to use as a coolant for the electric motor 140, the reagent H2O of the fuel cell 180 may also be used in a further on-board system 191 of the vehicle 1, for example, once again as a coolant for the on-board system and/or as service water or industrial water. For this purpose, the deionized water H2O, or at least a part thereof, is passed to the system 191 by way of a further media connection 182.

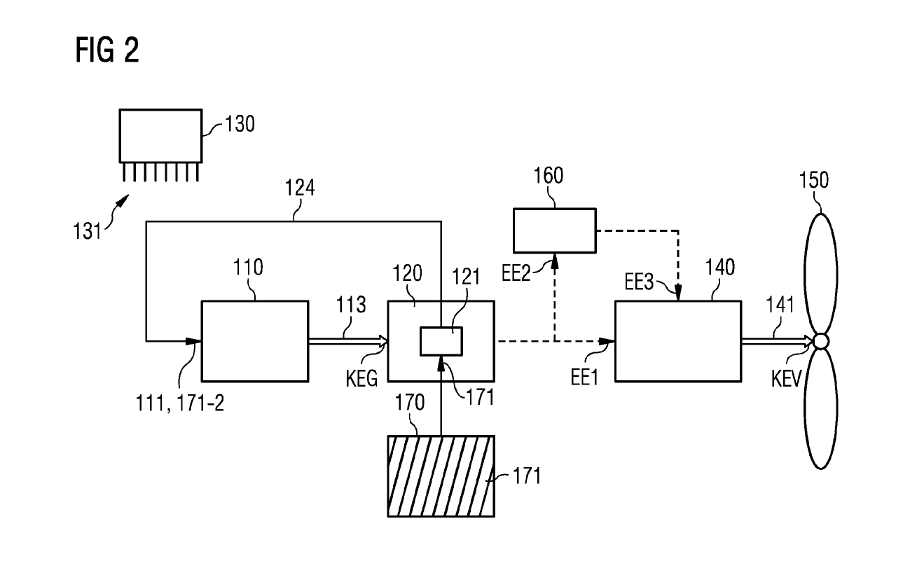

FIG. 2 depicts a second embodiment of the serial hybrid drive system 100. In this embodiment, the internal combustion engine 110 is a hydrogen turbine and, also in the second embodiment, the medium 111 to be burned is accordingly hydrogen. In the hydrogen turbine 110, fed hydrogen 111 is burned and the kinetic energy KEG for driving the HTS generator 120 is obtained.

As already described in connection with FIG. 1, also in the second embodiment, the temperature of the hydrogen located outside the tank 170 and in the vicinity of the generator 120 will rise over time and during the operation of the drive system 100 and of the generator 120. As soon as the predetermined target temperature is exceeded, at least a part 171-2 of the hydrogen is taken from the HTS generator 120 in a gaseous form. The hydrogen 171-2 that is taken is fed as medium 111 to be burned to the hydrogen turbine 110 by way of a media connection 124 for burning. The hydrogen 111 to be burned therefore corresponds to the hydrogen 171-2 taken from the HTS generator 120, or at least a part thereof.

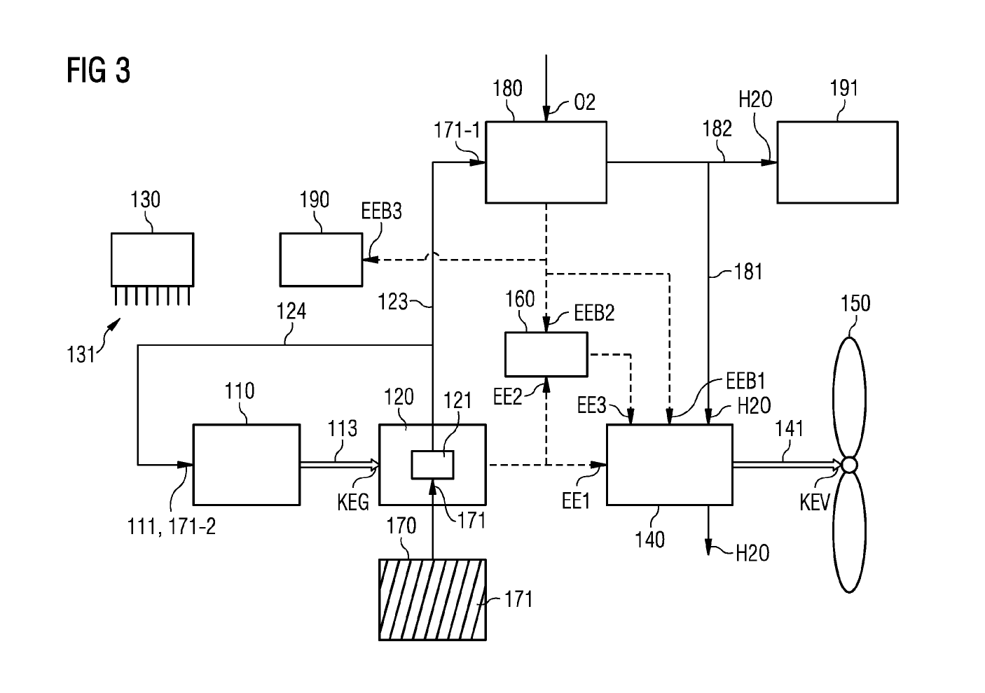

FIG. 3 depicts a third embodiment, in which the configurations of the drive system of the first and second embodiments are combined with one another, e.g., a part 171-1 of the coolant taken from the generator 120 is fed to the fuel cell 180 and a further part 171-2 reaches the internal combustion engine 110. The control unit 130 is designed to control the flows of coolant 171-1, 171-2 to the fuel cell 180 and to the internal combustion engine 110 in such a way that, situation-dependently, an optimum power output may be provided. The way in which the fuel cell 180 and the internal combustion engine 110 operate corresponds to the ways of operating described in connection with FIGS. 1 and 2.

For the case where the vehicle 1 is an aerial vehicle, as already mentioned the propulsion device 150 may be a propeller. For the likewise conceivable case where the vehicle 1 is a land vehicle, the propulsion device 150 may be a wheel. The manner of the transmission of the kinetic energy from the electric motor 140 to the actual propulsion device 150 is known per se and may be performed, for example, by way of shafts, spindles, gear mechanisms and/or other suitable mechanisms. This is not shown in detail in the drawings, and it is assumed that it is generally known in what manner kinetic energy may be transmitted from one component 140 to another component 150.

For the sake of clarity, the connections 131 of the control unit 130 to the various controllable components of the drive system 100 are merely indicated and not shown in detail. In order to provide the described operation of the drive system, the control unit 130 is however connected to all of the components of the drive system, in order to influence the way in which they operate.

The media connections 123, 124, 181 referred to may be for example pipelines or tubes with which gaseous or liquid media may be directed.

One of the advantages of the serial hybrid concept is that the electric motor and the internal combustion engine may run at different rotational speeds and, as a result, the maximum power output or the maximum efficiency for a given consumption may be achieved in both the motor and the engine. In order to decouple these two systems from one another, power electronics may be used between the generator and the electric motor, including one or more converters by which the voltage generated at the generator may be modulated both in frequency and amplitude. Not shown in the figures are possibly required electrical components of this type, which for example also allow a conversion of the DC current generated in the fuel cell into AC current or the mentioned conversion of the AC current of a first frequency and amplitude generated by the generator into an AC current of a different frequency and amplitude. Such components have no part to play for the embodiments disclosed herein. In addition, it is clear to a person skilled in the art that such components may possibly be interposed, or are interposed, in individual electrical connections in order to provide the transmission of the electrical energy between these components. For example, it may be assumed that there is a converter in the electrical connection between the generator 120 and the electric motor 140. It may also be assumed that, as already indicated, there is an inverter in the electrical connection between the fuel cell 180 and the electric motor 140. These and other such components have not been included in the figures for the sake of clarity.

Although the disclosure has been illustrated and described in detail by the exemplary embodiments, the disclosure is not restricted by the disclosed examples and the person skilled in the art may derive other variations from this without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1.-14. (canceled)

15. A drive system for driving a propulsion device of a vehicle, the drive system comprising:
an electric motor configured to drive the propulsion device;
a generator configured to provide a first electrical energy, wherein the generator is electrically connected to the electric motor in order to feed at least a first part of the first electrical energy to the electric motor to drive the electric motor,
wherein the generator is a cryogenic generator having at least one cryogenic component, the generator configured to be brought to a cryogenic temperature by a coolant fed to the generator and to the cryogenic component, wherein the cryogenic component has a conductivity at the cryogenic temperature that is increased by at least one order of magnitude as compared with a conductivity of the cryogenic component at 0° C.,
wherein the generator is connected to a device of the drive system to which at least a part of the coolant is configured to be passed after satisfying a predetermined criterion, and
wherein the device is configured to process the fed coolant to provide an energy to be used in the drive system.

16. The drive system of claim 15, wherein the vehicle is an aerial vehicle.

17. The drive system of claim 15, wherein the cryogenic generator is a superconducting generator.

18. The drive system of claim 15, wherein the coolant is hydrogen.

19. The drive system of claim 18, wherein the coolant is in a liquid state.

20. The drive system of claim 15, wherein the at least part of the coolant is configured to be passed in a gaseous state.

21. The drive system of claim 15, wherein the device is a fuel cell,
wherein the generator is connected to the fuel cell by a first media connection, by which at least a first part of the coolant is configured to be passed from the generator to the fuel cell after satisfying the predetermined criterion,
wherein the coolant is configured to enter into a chemical reaction in the fuel cell with a reaction partner to produce a second electrical energy and a reaction product.

22. The drive system of claim 21, wherein the fuel cell is connected to the electric motor by a second media connection, by which the reaction product is configured to be fed to the electric motor as a cooling medium to cool the electric motor.

23. The drive system of claim 21, wherein the fuel cell is electrically connected to the electric motor,
wherein at least a first part of the second electrical energy is configured to be passed from the fuel cell to the electric motor to drive the electric motor.

24. The drive system of claim 21, further comprising:
a battery,
wherein at least a second part of the second electrical energy is configured to be fed to and stored within the battery, and
wherein the battery is electrically connected to one or more electrical components of the vehicle, so that electrical energy stored in the battery is configured to be provided to the respective electrical component.

25. The drive system of claim 15, further comprising:
an internal combustion engine configured to drive the generator,
wherein the internal combustion engine is configured to provide kinetic energy by burning a medium,
wherein the internal combustion engine is mechanically connected to the generator to feed the provided kinetic energy to the generator,
wherein the generator is configured to convert the fed kinetic energy into the first electrical energy,
wherein the medium to be burned is the coolant, and
wherein the generator is connected to the internal combustion engine by a media connection, by which at least a second part of the coolant is configured to be passed from the generator to the internal combustion engine after satisfying the predetermined criterion, in order to be burned within the internal combustion engine.

26. The drive system of claim 15, wherein the predetermined criterion is that of exceeding a predetermined temperature.

27. A method for operating a drive system to drive a propulsion device of a vehicle, the method comprising:
feeding a coolant to a cryogenic generator of the drive system and to a cryogenic component of the cryogenic generator, bringing the cryogenic generator to a cryogenic temperature, wherein the cryogenic component has a conductivity at the cryogenic temperature that is increased by at least one order of magnitude as compared with a conductivity of the cryogenic component at 0° C.;
feeding, by the cryogenic generator, a first electrical energy to an electric motor of the drive system; and
driving the propulsion device by the electric motor of the drive system,
wherein the cryogenic generator is connected to a device of the drive system to which at least a part of the coolant is passed after satisfying a predetermined criterion, and
wherein the device processes the fed coolant to provide an energy to be used in the drive system.

28. The method of claim 27, wherein the cryogenic generator is a superconducting generator.

29. The method of claim 27, wherein the coolant is hydrogen.

30. The method of claim 29, wherein the coolant is in a liquid state.

31. The method of claim 27, wherein the at least part of the coolant is configured to be passed in a gaseous state.

32. The method of claim 27, wherein the device is a fuel cell,
wherein at least a first part of the coolant is passed from the generator to the fuel cell after satisfying the predetermined criterion,
wherein the coolant enters into a chemical reaction in the fuel cell with a reaction partner to produce a second electrical energy and a reaction product.

33. The method of claim 32, wherein the reaction product is fed to the electric motor in order to cool the electric motor.

34. The method of claim 32, wherein at least a first part of the second electrical energy is passed from the fuel cell to the electric motor to drive the electric motor.

35. The method of claim 32, wherein the drive system has a battery,
wherein at least a second part of the second electrical energy is fed to and stored within the battery, and
wherein the battery is electrically connected to one or more electrical components of the vehicle, so that electrical energy stored in the battery is provided to the respective electrical component.

36. The method of claim 27, wherein the generator is driven by an internal combustion engine of the drive system,
wherein the internal combustion engine provides kinetic energy by burning a medium,
wherein the provided kinetic energy is fed to the generator,
wherein the generator converts the fed kinetic energy into the first electrical energy,
wherein the medium to be burned is the coolant, and
wherein at least a second part of the coolant is passed from the generator to the internal combustion engine after satisfying the predetermined criterion, in order to be burned within the internal combustion engine.

37. The method of claim 27, wherein the predetermined criterion is that of exceeding a predetermined temperature.
